(19) United States
(12) Patent Application Publication
(10) Pub. No.: US 2008/0318141 A1
(43) Pub. Date: Dec. 25, 2008

(54) METHOD OF PREPARING TONER AND TONER PREPARED USING THE METHOD

(75) Inventors: Yo-da SHIN, Incheon Metropolitan City (KR); Kyung-yol YON, Seongnam-si (KR); Kyeong PANG, Suwon-si (KR); Tae-hoe KOO, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/018,388

(22) Filed: Jan. 23, 2008

(30) Foreign Application Priority Data
Jun. 19, 2007 (KR) 2007-60040

(51) Int. Cl. G03G 13/14; G03G 9/087; G03G 15/16

(52) U.S. Cl. 430/48; 430/137.14; 430/111.1; 399/310

(57) ABSTRACT

A method of preparing toner, the method including preparing a latex for a core by polymerizing a composition for a core including a macromonomer having a hydrophilic group, a hydrophobic group and at least one reactive functional group, at least one polymerizable monomer, and a wax; agglomerating the latex for a core by adding a pigment dispersion dispersed by the macromonomer and an inorganic salt to the prepared latex for a core; and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer, and toner prepared according to the method.

### CROSS-REFERENCE TO RELATED APPLICATIONS

This application claims priority under 35 U.S.C. §119(a) from Korean Patent Application No. 10-2007-0060040, filed on Jun. 19, 2007, in the Korean Intellectual Property Office, the disclosure of which is incorporated herein in its entirety by reference.

### BACKGROUND OF THE INVENTION

1. Field of the Invention

The present general inventive concept relates to a method of preparing toner and toner prepared using the method, and more particularly, to a method of preparing toner having improved durability and excellent charge stability by forming a shell layer having polydimethyl siloxane units on a surface of the toner particles to increase affinity between the toner and external additives, increase an amount of the external additives on the surface of the toner, and obtain uniform distribution of the external additives, toner prepared using the method, a method of forming an image using the toner, and an image forming apparatus employing the toner.

2. Description of the Related Art

In an electrophotographic image forming process or electrostatic recording process, a developer used to shape an electrostatic image or an electrostatic latent image can be classified into a two-component developer formed of toner and carrier particles, and a one-component developer formed of toner only. The one-component developer can be classified into a magnetic one-component developer and a nonmagnetic one-component developer. Fluidizing agents, such as colloidal silica, are often independently added to the nonmagnetic one-component developer to increase a fluidity of the toner. Typically, coloring particles obtained by dispersing a pigment, such as carbon black, or other additives in a binding resin are used in the toner.

Methods of preparing toner include pulverization and polymerization. In pulverization, toner is obtained by melting and mixing synthetic resins with pigments and, if required, other additives, pulverizing the mixture, and sorting the particles until particles of a desired size are obtained. In polymerization, a polymerizable monomer composition is manufactured by uniformly dissolving or dispersing various additives, such as a pigment, a polymerization initiator and, if required, a cross-linking agent and an antistatic agent, in a polymerizable monomer. Then, the polymerizable monomer composition is dispersed in an aqueous dispersive medium which includes a dispersion stabilizer using an agitator to shape minute liquid droplet particles. Subsequently, the temperature is increased and suspension polymerization is performed to obtain polymerized toner having coloring polymer particles of a desired size.

In an image forming device, such as an electrophotographic device or an electrostatic recording device, an image is formed by exposing an image on a uniformly charged photoreceptor to form an electrostatic latent image, attaching toner to the electrostatic latent image to form a toner image, transferring the toner image onto a transfer member, such as transfer paper or the like, and then fixing the toner image on the transfer member by any of a variety of methods, including heating, pressurizing, solvent steaming, and the like. In most fixing processes, the transfer medium with the toner image passes through fixing rollers and pressing rollers, and by heating and pressing, the tone image is fused to the transfer medium.

Images formed by an image forming apparatus, such as electrophotographic device, should satisfy requirements of high precision and accuracy. Conventionally, toner used in an image forming apparatus is usually obtained using pulverization. In pulverization, color particles having a large range of size distribution are formed. Hence, to obtain satisfactory developing properties, there is a need to sort the coloring particles obtained through pulverization according to size to reduce the particle size distribution. However, it is difficult to precisely control the particle size and the particle size distribution using a conventional mixing/pulverizing process in the manufacture of toner suitable for an electrophotographic process or an electrostatic recording process. Also, when preparing a fine particle toner, the toner preparation yield is adversely affected by the sorting process. In addition, there are limits to change/adjustment of a toner design for obtaining desirable charging and fixing properties. Accordingly, polymerized toner, in which a size of particles is easy to control and which do not need to undergo a complex manufacturing process, such as sorting, have been highlighted recently.

When toner is prepared through polymerization, polymerized toner having a desired particle size and particle size distribution can be obtained without pulverizing or sorting. However, although such polymerization is used, a surfactant is required to disperse a pigment. The use of the surfactant requires a washing process, and thus, manufacturing costs are increased and an amount of wastewater generated is also increased.

For example, U.S. Pat. No. 6,258,911 discloses a bifunctional polymer having narrow polydispersity and a method of emulsification-aggregation polymerization for preparing a polymer having free radicals that are covalently-bonded at both ends of the polymer. In such an emulsification-aggregation polymerization, toner particles are prepared by separately preparing a wax dispersion and a pigment dispersion using an ionic surfactant (typically an anionic surfactant), dispersing the prepared polymer latex particles with the wax dispersion and the pigment dispersion using a surfactant, and then agglomerating the resultant dispersion. Alternatively, a polymer latex (or seed) is polymerized in a first operation, and the seed is polymerized with a wax-monomer emulsified dispersion using a seed-treated emulsion polymerization in a second operation, and then toner particles are prepared by agglomerating the dispersed pigment using a surfactant. A method of preparing toner using the conventional emulsification-aggregation is complicated and the surfactant cannot be easily removed, resulting in various problems due to residual surfactant. Particularly, the conventional methods require additional operations, such as a washing process, and thus increase pollution to the environment and increase manufacturing costs.

In addition, there is still a need to use a macroinitiator having functional units in addition to the typical initiator when the latex is synthesized to prepare toner in order to overcome problems, such as where the amount of the external additives is insufficient and the external additives are not uniformly distributed when the toner is subjected to a surface treatment.

### SUMMARY OF THE INVENTION

The present general inventive concept provides a method of preparing toner having improved durability and excellent charge stability by using simplified manufacture processes, which minimizes an amount of wastewater generated using a reduced amount of a surfactant, and improves affinity between toner and external additives to increase an amount of external additives on a surface of the toner and obtain uniform distribution of the external additives.

The present general inventive concept also provides toner prepared using the method.

The present general inventive concept also provides toner having improved durability and excellent charge stability by improving affinity between toner and external additives to increase the amount of the external additives on the surface of the toner and obtain uniform distribution of the external additives.

The present general inventive concept also provides a method of forming an image using the toner having improved durability and excellent charge stability by improving affinity between toner and external additives to increase the amount of the external additives on the surface of the toner and obtain uniform distribution of the external additives, wherein a high-quality image is fixed at a low fixing temperature.

The present general inventive concept also provides an image forming apparatus employing the toner having improved durability and excellent charge stability by improving affinity between the toner and external additives to increase the amount of the external additives on the surface of the toner and obtain uniform distribution of the external additives, wherein a high-quality image is fixed at a low fixing temperature.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of preparing toner, the method including preparing a latex for a core by polymerizing a composition for a core including a macromonomer having a hydrophilic group, a hydrophobic group, and at least one reactive functional group, at least one polymerizable monomer, and a wax, agglomerating the latex for a core by adding a pigment dispersion dispersed by the macromonomer and an inorganic salt to the prepared latex for a core, and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

The foregoing and/or other aspects and utilities of the present general inventive concept may also be achieved by providing a toner prepared using a method including preparing a latex for a core by polymerizing a composition for a core including a macromonomer having a hydrophilic group, a hydrophobic group, and at least one reactive functional group, at least one polymerizable monomer, and a wax, agglomerating the latex for a core by adding a pigment dispersion dispersed by the macromonomer and an inorganic salt to the prepared latex for a core, and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer, and wherein at least one operation of the preparing of a latex for a core, the agglomerating of the latex for a core, the preparing of a latex for a shell layer, and the coating of the agglomerated latex for a core using the latex for a shell layer is carried out without a surfactant.

The foregoing and/or other aspects and utilities of the present general inventive concept may also be achieved by providing toner prepared using a method including preparing a latex for a core by polymerizing a composition for a core including a macromonomer having a hydrophilic group, a hydrophobic group, and at least one reactive functional group, at least one polymerizable monomer, and a wax, agglomerating the latex for a core by adding a pigment dispersion dispersed by the macromonomer and an inorganic salt to the prepared latex for a core, and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

The foregoing and/or other aspects and utilities of the present general inventive concept may also be achieved by providing a method of forming an image using toner, the method comprising attaching the toner to a surface of a photoreceptor on which an electrostatic latent image is formed to form a visualized image, and transferring the visualized image to a transfer medium, wherein the toner is prepared using a method including preparing a latex for a core by polymerizing a composition for a core including a macromonomer having a hydrophilic group, a hydrophobic group, and at least one reactive functional group, at least one polymerizable monomer, and a wax, agglomerating the latex for a core by adding a pigment dispersion dispersed by the macromonomer and an inorganic salt to the prepared latex for a core, and coating the agglomerated latex for a core using a latex for a shell layer, and wherein the latex for a shell layer is prepared by polymerizing a composition for a shell layer including at least one polymerizable monomer, a macroinitiator having polydimethyl siloxane units, and a macromonomer.

The foregoing and/or other aspects and utilities of the present general inventive concept may also be achieved by providing an image forming apparatus including an organic photoreceptor, an image forming unit that forms an electrostatic latent image on a surface of the organic photoreceptor, a unit for receiving a toner, a toner supplying unit that supplies the toner onto the surface of the organic photoreceptor in order to form a toner image by developing the electrostatic latent image, and a toner transferring unit that transfers the toner image to a transfer medium from the surface of the organic photoreceptor, wherein the toner is prepared using a method including preparing a latex for a core by polymerizing a composition for a core including a macromonomer having a hydrophilic group, a hydrophobic group, and at least one reactive functional group, at least one polymerizable monomer, and a wax, agglomerating the latex for a core by adding a pigment dispersion dispersed by the macromonomer and an inorganic salt to the prepared latex for a core, and coating the agglomerated latex for a core using a latex for a shell layer, and wherein the latex for a shell layer is prepared by polymerizing a composition for a shell layer including at least one polymerizable monomer, a macroinitiator having polydimethyl siloxane units, and a macromonomer.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an image forming apparatus employing toner prepared according to an embodiment of the present general inventive concept;

FIG. 2 illustrates a scanning electron microscope (SEM) image of toner prepared according to Example 1;

FIG. 3 illustrates a SEM image of toner prepared according to Example 2;

FIG. 4 illustrates a SEM image of toner prepared according to Example 3;

FIG. 5 illustrates a SEM image of toner prepared according to Comparative Example 1;

FIG. 6 illustrates a SEM image of toner prepared according to Comparative Example 2; and

FIG. 7 illustrates a SEM image of toner prepared according to Comparative Example 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides a method of preparing toner using simplified manufacturing processes, which minimizes an amount of wastewater by using a reduced amount of a surfactant. Particularly, the amount of the surfactant can be dramatically reduced while the dispersing ability of a pigment is maintained by dispersing the pigment using a macromonomer which has dispersing ability with a hydrophilic group and a hydrophobic group. Accordingly, various problems caused by excessive use of surfactant can be solved.

In addition, affinity between toner and external additives is increased by forming a shell layer having polydimethyl siloxane units on the surface of the toner, and thus an amount of the external additives can increase and uniform distribution of the external additives can be obtained. As a result, the toner can have thermal resistance, water repellent property, lubricity, releasing property, biocompatibility, and gas permeability, and thus toner for high quality and high speed printers which has improved durability, excellent charge stability, high storing capacity, and desired particulate structure can be prepared.

The present general inventive concept provides a method of preparing toner, the method including preparing a latex for a core by polymerizing a composition for a core including (i) a macromonomer having a hydrophilic group, a hydrophobic group and at least one reactive functional group, (ii) at least one polymerizable monomer, and (iii) a wax; agglomerating the latex for a core by adding a pigment dispersion dispersed by the macromonomer and an inorganic salt to the prepared latex for a core; and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

A molecular weight, glass transition temperature (Tg), and Theological properties of the core of the toner prepared according to the method may be controlled to be fixed at a low fixing temperature.

The Theological properties are determined by complex modulus, i.e., storage modulus (G′) and loss modulus (G″) determined by dynamic tests, and controlled by complex viscosity. In addition, relaxation modulus of elasticity and relaxation time can be measured. Such stress-relaxation behavior is affected by molecular weight and structure of the toner binder resin, and an amount of wax contained in the toner. When the complex viscosity is too low (less than 1.0×10² Pas), offset or peeling failure may occur in a fusing device. On the other hand, when the complex viscosity is too high (higher than 1.0×10⁴ Pas), adhesion may not be sufficient when fused and glossiness may decrease, and thus the toner may not be efficiently applied to paper.

Meanwhile, when the molecular weight (Mw) of the binder resin is controlled to be less than 30,000, Tg is controlled to be about 50° C., and rheological properties are decreased, the fusing ratio can be increased, but problems, such as offset, may occur. To overcome such problems, a method of cross-linking resins has been used by controlling reactivity of the macromonomer participating in the polymerization. However, problems, such as decrease in durability, have not been completely overcome. Accordingly, in the present general inventive concept, toner is encapsulated by coating toner particles using the shell layer to improve durability and to solve storage problems during shipping and handling.

Here, an inhibitor may further be added to the reactor to prevent new latex particles from being formed, or the reaction may be performed using starved-feed processes to facilitate coating of the monomer mixture on the toner.

Since the macromonomer used as a comonomer during the polymerization of the latex according to the present general inventive concept maintains stability of the latex in an aqueous solution, a surfactant does not need to be used in the preparation and agglomeration of the polymer latex.

That is, at least one operation of the preparing of a latex for a core, the agglomerating of the latex for a core, the preparing of a latex for a shell layer, and the coating of the agglomerated latex for a core using the latex for a shell layer may be carried out without a surfactant.

The latex for a core may be prepared by polymerizing a composition for a core including a macromonomer having a hydrophilic group, a hydrophobic group and at least one reactive functional group, at least one polymerizable monomer, and a wax.

The macromonomer used herein is an amphiphilic material which has a hydrophilic group and a hydrophobic group in a polymer or oligomer form having at least one reactive functional group at its end.

The hydrophilic group of the macromonomer which is chemically combined on the surface of toner particles improves long term stability of the toner particles by steric stabilization, and a size of latex particles can be adjusted according to the amount or molecular weight of the added macromonomer. The hydrophobic group of the macromonomer which is on the surface of the toner particles can facilitate emulsion polymerization reaction. The macromonomer may form a copolymer with the polymerizable monomer included in the toner composition by grafting, branching, cross-linking, or the like.

A weight average molecular weight of the macromonomer may be in the range of 100 to 100,000, and preferably 1,000 to 10,000. When the weight average molecular weight of the macromonomer is less than 100, physical properties of the toner are not improved or the toner cannot efficiently function as a stabilizer. On the other hand, when the weight average molecular weight of the macromonomer is greater than 100,000, the reaction conversion rate may be lowered.

The macromonomer may be one of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate, but the present general inventive concept is not limited thereto.

The macromonomer can function not only as a comonomer but also as a stabilizer. Initial reaction of radicals and monomers creates oligomer radicals and shows an in-situ stabilization effect. An initiator dissolved by heat creates radicals and reacts with a monomer in an aqueous solution to form an oligomer radical, and the hydrophobicity of the solution increases. Such hydrophobicity of oligomer radicals facilitates diffusion into micelle and facilitates reaction with polymerizable monomers, and together with this, a copolymerization reaction with macromonomers can be processed.

Due to the hydrophilicity of the macromonomer, copolymerization can easily occur in a vicinity of the surface of the toner particles. The hydrophilic portions of the macromonomer located on the surface of the toner particles increase stability of the toner particles by steric stabilization, and the size of the toner particles can be adjusted according to the amount or molecular weight of the macromonomers. Also, functional groups reacting on the surface of the toner particles can improve the frictional electrical properties of the toner.

The polymerizable monomer may be at least one of a vinyl monomer, a polar monomer having a carboxyl group, a monomer having an unsaturated polyester group, and a monomer having a fatty acid group.

The polymerizable monomer may be one of styrene-based monomers, such as styrene, vinyl toluene, and α-methyl styrene; acrylic acid or methacrylic acid; derivatives of (metha)acrylates, such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide; ethylenically unsaturated monoolefins such as ethylene, propylene, and butylenes; halogenized vinyls such as vinyl chloride, vinylidene chloride, and vinyl fluoride; vinyl esters, such as vinyl acetate, and vinyl propionate; vinyl ethers, such as vinyl methyl ether, and vinyl ethyl ether; vinyl ketones, such as vinyl methyl ketone, and methyl isoprophenyl ketone; and nitrogen-containing vinyl compounds, such as 2-vinylpyridine, 4-vinylpyridine, and N-vinyl pyrrolidone, but the present general inventive concept is not limited thereto.

The composition for a core according to the present general inventive concept may include 0.5 to 40 parts by weight, preferably 2 to 20 parts by weight, and more preferably 2 to 10 parts by weight of the macromonomer based on 100 parts by weight of the polymerizable monomer.

When the amount of the macromonomer is less than 0.5 parts by weight, dispersion stability of the toner particles may decrease and yield may decrease. On the other hand, when the amount of the macromonomer is greater than 40 parts by weight, physical properties of the toner may deteriorate.

The wax may be appropriately selected according to a purpose of the final toner. Examples of the wax include polyethylene-based wax, polypropylene-based wax, silicon wax, paraffin-based wax, ester-based was, carbauna wax, and metallocene wax, but the present general inventive concept is not limited thereto. The melting point of the wax may be in the range of about 50 to about 150° C. Wax constituents are physically attached to the toner particles, but are preferably not covalently bonded with toner particles. Thus, a toner that is fixed at a low fixing temperature on a final image receptor and shows excellent final image durability and resistance to abrasion can be provided.

The amount of wax in the composition for a core may be in the range of 1 to 40 parts by weight, preferably 5 to 20 parts by weight, and more preferably 10 to 20 parts by weight based on 100 parts by weight of the polymerizable monomer.

When the amount of the wax is less than 1 part by weight, a fusing ratio may decrease. On the other hand, when the amount of the wax is greater than 40 parts by weight, physical properties of the toner may deteriorate.

A medium used herein to prepare toner may be an aqueous solution, an organic solvent, or a mixture thereof.

The preparing a latex for a core may be performed further using at least one of an initiator, a chain transfer agent, a charge control agent, and a release agent.

That is, in the preparation process, radicals may be created by the initiator in the toner composition, and the radicals may react with the polymerizable monomer. The radicals may form a copolymer by reacting with the polymerizable monomer and reactive functional groups of the macromonomer.

Examples of the initiator for radical polymerization include persulfate salts, such as potassium persulfate, and ammonium persulfate; azo compounds, such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1,1-bis(hydroxymethyl)-2-hydroxyethylpropioamide, 2,2′-azobis(2,4-dimethyl valeronitrile), 2,2′-azobis isobutyronitrile, and 1,1′-azobis(1-cyclohexanecarbonitrile); and peroxides, such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, and di-t-butylperoxy isophthalate. Also, an oxidization-reduction initiator in which the polymerization initiator and a reduction agent are combined may be used.

A chain transfer agent is a material that converts a type of chain carrier in a chain reaction. A new chain has much less activity than that of a previous chain. The polymerization degree of the monomer can be reduced and new chains can be initiated using the chain transfer agent. In addition, a molecular weight distribution can be adjusted using the chain transfer agent.

Examples of the chain transfer agent include sulfur containing compounds, such as dodecanthiol, thioglycolic acid, thioacetic acid, and mercaptoethanol; phosphorous acid compounds, such as phosphorous acid and sodium phosphite; hypophosphorous acid compounds, such as hypophosphorous acid and sodium hypophosphite; and alcohols, such as methyl alcohol, ethyl alcohol, isopropyl alcohol, and n-butyl alcohol, but the present general inventive concept is not limited thereto.

The charge control agent may be preferably selected from a group consisting of a salicylic acid compound containing metals, such as zinc and aluminum, boron complexes of bis diphenyl glycolic acid, and silicate. More preferably, dialkyl salicylic acid zinc, boro bis(1,1-diphenyl-1-oxo-acetyl potassium salt), or the like can be used.

A release agent can be used to protect a photoreceptor and prevent deterioration of developing, thereby obtaining a high quality image. The release agent may be a high purity solid fatty acid ester material. Examples of the release agent include low molecular weight polyolefins, such as low molecular weight polyethylene, low molecular weight polypropylene, and low molecular weight polybutylene; paraffin wax; and multi-functional ester compounds. The release agent used in the present general inventive concept may be a multifunctional ester compound composed of alcohol having three functional groups or more and carboxylic acid.

The alcohol having three functional groups or more may be aliphatic alcohols, such as glycerin, pentaerythritol, and pentaglycerol; alicyclic alcohols, such as chloroglycitol, quersitol, and inositol; aromatic alcohols, such as tris(hydroxymethyl)benzene; sugars, such as D-erythrose, L-arabinose, D-mannose, D-galactose, D-fructose, L-lamunose, sucrose, maltose, and lactose; or sugar-alcohols, such as erythrite.

The carboxylic acid may be aliphatic carboxylic acids, such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, and tetrolic acid; alicyclic carboxylic acids, such as cyclohexanecarboxylic acid, hexahydroisophthalic acid, hexahydroterephthalic acid, and 3,4,5,6-tetrahydrophthalic acid; or aromatic carboxylic acids, such as benzoic acid, cumic acid, phthalic acid, isophthalic acid, terephthalic acid, trimeth acid, trimellitic acid, and hemimellitic acid.

The latex for a shell layer may be prepared by polymerizing a composition for a shell layer including at least one polymerizable monomer, a macroinitiator having polydimethyl siloxane units, and a macromonomer.

The polymerizable monomer may be one of a vinyl monomer, a polar monomer having a carboxyl group, a monomer having an unsaturated polyester group, and a monomer having a fatty acid group. Particularly, the polymerizable monomer described above may be used, and the macromonomer described above may be used.

In the composition for a shell layer, the amount of the macromonomer may be in the range of 0.1 to 10 parts by weight, preferably 2 to 7 parts by weight, and more preferably 2 to 4 parts by weight based on 100 parts by weight of the polymerizable monomer.

When the amount of the macromonomer is less than 0.1 parts by weight, stability of the latex particles may decrease. On the other hand, when the amount of the macromonomer is greater than 10 parts by weight, physical properties of the latex may deteriorate.

The macroinitiator having polydimethyl siloxane units may be prepared by copolymerizing silicon units using a vinyl monomer as a starting material. When the macroinitiator is used to prepare a polymer material, properties of silicon, such as thermal resistance, water repellent property, lubricity, releasing property, biocompatibility, and gas permeability may be efficiently provided to the polymer material.

In addition, fluidity of the toner may be improved and charged electric charge amount can be controlled by coating the latex for a shell layer on the agglomerated latex for a core and carrying out a surface treatment using an external additive, such as silica. Here, when the macroinitiator having polydimethyl siloxane units is used, chemical affinity between the external additive and the shell layer may be improved. Durability of the toner can also be improved due to viscoelasticity of the silicon.

The weight average molecular weight of the polydimethyl siloxane in the macroinitiator having the polydimethyl siloxane units (silicon) may be in the range of 1,000 to 100,000, and preferably 3,000 to 20,000. When the weight average molecular weight of the polydimethyl siloxane is less than 1,000, peculiar properties of the macroinitiator may not be properly expressed. On the other hand, when the weight average molecular weight of the polydimethyl siloxane is greater than 100,000, efficiency of the initiator may decrease. The macroinitiator having polydimethyl siloxane units may be represented by Formula I below:

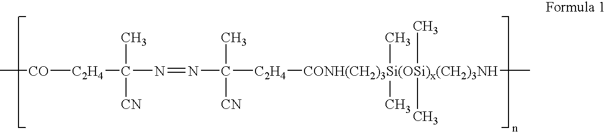

where, n is an integer from 1 to 50, and x is an integer from 20 to 1,000.

Examples of the macroinitiator having polydimethyl siloxane units include VPS-0501 or VPS-1001 manufactured by Wako Pure Chemical Industries. Here, the molecular weight of polydimethyl siloxane of VPS-0501 is about 5,000, and the molecular weight of the polydimethyl siloxane of VPS-1001 is about 10,000.

In the composition for a shell layer, the amount of the macroinitiator having polydimethyl siloxane units may be in the range of 1 to 20 parts by weight, and preferably 5 to 15 parts by weight based 100 parts by weight of the polymerizable monomer. When the amount of the macroinitiator is less than 5 parts by weight, peculiar properties of the macroinitiator may not be properly expressed. On the other hand, when the amount of the macroinitiator is greater than 20 parts by weight, efficiency as the initiator may decrease.

Processes of preparing and agglomerating a latex for a core of toner particles, and coating the agglomerated latex for a core using a latex for a shell layer according to the present general inventive concept will be described in detail.

First, a latex for a core is prepared by polymerizing a composition for a core including a macromonomer described above, at least one polymerizable monomer and a wax. More particularly, while an inside of a reactor is purged with nitrogen gas or the like, a mixture solution of a medium, such as distilled deionized water (or a mixture of water and an organic solvent), and the macromonomer is added to the reactor and heated while stirring. An electrolyte or an inorganic salt, such as NaOH or NaCl, may be added thereto to adjust ionic strength of the reaction medium. When a temperature inside the reactor reaches a certain level, an initiator, preferably a water-soluble free radical initiator, may be introduced. Then, at least one polymerizable monomer may be added to the reactor using a semi-continuous method with a chain transfer agent. Here, polymerizable monomer may be slowly provided using a starved feed process to adjust a reaction speed and dispersibility of the solution.

The polymerization may be performed in the range of 4 to 12 hours and a polymerization time is dependent on the reaction temperature and experimental conditions and determined by measuring reaction speed and conversion rate. The latex for a core may be prepared by adding additional monomers to adjust durability or other properties of the toner.

When the latex for a core is prepared, a pigment is dispersed using the macromonomer since the macromonomer can maintain dispersibility by having both the hydrophilic group and the hydrophobic group. A milling or a homogenizer may be used without limitation as dispersing means and the latex for a core is agglomerated by adding an inorganic salt to the prepared pigment dispersion.

Then, the prepared latex for a shell layer is coated on the agglomerated latex for a core to obtain toner particles having desired size and structure, and then the resultant is filtered to separate the toner particles and dried. The dried toner particles are subjected to a surface treatment using external additives.

Examples of the external additives used in the surface treatment include silica, TiO₂, and polymer beads, and the external additives can improve a fluidity of the final toner and control an amount of charged electric charges.

In addition, the latex for a shell layer is prepared in a similar manner to the preparation of the latex for a core using a composition for a shell layer including at least one polymerizable monomer, a macroinitiator having polydimethyl siloxane units, and a macromonomer.

That is, while the inside of a reactor is purged with nitrogen gas or the like, a mixture solution of a medium, such as distilled deionized water (or a mixture of water and an organic solvent), and the macromonomer is added to the reactor and heated while stirring. An electrolyte or an inorganic salt, such as NaOH or NaCl, may be added thereto to adjust ionic strength of the reaction medium. When the temperature inside the reactor reaches a certain level, a macroinitiator having the polydimethyl siloxane units is introduced to initiate the reaction. Then, at least a polymerizable monomer and a charge control agent are added to the reactor using a semi-continuous method, preferably with a chain transfer agent. Here, polymerizable monomers may be slowly provided using a starved feed process to adjust a reaction speed and dispersibility of the solution. The polymerization may be performed in the range of 4 to 8 hours and the polymerization time is dependent on the reaction temperature and experimental conditions and is determined by measuring reaction speed and conversion rate.

Since at least one operation of the preparing of a latex for a core, the agglomerating of the latex for a core, the preparing of a latex for a shell layer, and the coating of the agglomerated latex for a core using the latex for a shell layer is carried out without a surfactant, washing processes may be minimized in the separation and filtration of the prepared toner particles. Manufacturing costs for the toner may be reduced by minimizing the number of washing processes, and the manufacturing process is more environmentally friendly by decreasing the amount of wastewater generated. Further, problems, such as high sensitivity in high humidity, low frictional charge, reduced dielectric property, and weak toner flow, may be removed since a surfactant is not used. Also, storage stability of the toner can be improved.

The toner may include a pigment, and carbon black or aniline black may be used as the pigment for a black toner. A nonmagnetic toner according to the present general inventive concept is efficient for preparing color toner. For color toner, carbon black or aniline black is used as a black colorant, and at least one of yellow, magenta, and cyan pigments are further included for colored colorants.

A condensation nitrogen compound, an isoindolinone compound, an anthraquine compound, an azo metal complex, or an allyl imide compound can be used for the yellow pigment. Particularly, C.I. pigment yellow 12, 13, 14, 17, 62, 74, 83, 93, 94, 95, 109, 110, 111, 128, 129, 147, 168, 180, orthe like can be used.

A condensation nitrogen compound, an anthraquine compound, a quinacridone compound, a base dye lake compound, a naphthol compound, a benzo immidazole compound, a thioindigo compound, or a perylene compound can be used for the magenta pigment. Particularly, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, or the like can be used.

A copper phthalocyanine compound and derivatives thereof, an anthraquine compound, or a base dye lake compound can be used for the cyan pigment. Particularly, C.I. pigment blue 1, 7, 15, 15:1, 15:2, 15:3, 15:4, 60, 62, 66, or the like can be used.

Such pigments can be used alone or in a combination of at least two pigments, and can be selected in consideration of color, chromacity, luminance, resistance to weather, dispersion property in toner, etc.

The amount of the pigment as described above is preferably 0.1 to 20 parts by weight based on 100 parts by weight of the polymerizable monomer. The amount of the pigment should be sufficient to color the toner; however, when the amount of the pigment is less than 0.1 parts by weight based on 100 parts by weight of the polymerizable monomer, the coloring effect is not sufficient. On the other hand, when the amount of the pigment is greater than 20 parts by weight, the manufacture costs of the toner increase, and thus sufficient frictional charge amount cannot be obtained.

In addition, the latex for a core can be agglomerated by adding an inorganic salt to a mixed solution of the latex for a core and the pigment dispersion. That is, the size of the agglomerated latex for a core increases due to increased ionic strength by the addition of the inorganic salt and collisions between the particles.

Particularly, when a concentration of the inorganic salt is heavier than a critical coagulation concentration (CCC), an electrostatic repulsive force between latex particles is offset, and thus agglomeration rapidly occurs due to Brownian motion of the latex for a core. When a concentration of the inorganic salt is lower than the CCC, agglomeration speed becomes slow, and thus agglomeration of the latex can be controlled. The inorganic salt may be at least one of NaCl, MgCl₂.8H₂O, [Al₂(OH)ₙCl₆₋ₙ]ₘ where 1≦n≦5 and 1≦m≦10, and (Al₂(SO₄)₃.18H₂O, but the present general inventive concept is not limited thereto.

According to another embodiment of the present general inventive concept, there is provided toner prepared using a method including preparing a latex for a core by polymerizing a composition for a core including (i) a macromonomer having a hydrophilic group, a hydrophobic group and at least one reactive functional group (ii) at least one polymerizable monomer and (iii) a wax; agglomerating the latex for a core by adding a pigment dispersion dispersed by the macromonomer and an inorganic salt to the prepared latex for a core; and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

At least one operation of the preparing a latex for a core, the agglomerating the latex for a core, the preparing a latex for a shell layer, and the coating the agglomerated latex for a core using the latex for a shell layer may be carried out without a surfactant and detailed descriptions thereof are described above.

A volume average diameter of particles of the toner may be in the range of 5 to 10 μm, and preferably 5 to 7 μm.

A weight average molecular weight of the macromonomer may be in the range of 100 to 100,000, and preferably 1,000 to 10,000. Examples of the macromonomer include polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate, but the present general inventive concept is not limited thereto.

According to another embodiment of the present general inventive concept, there is provided a method of forming an image using a toner, the method including attaching the toner to a surface of a photoreceptor on which an electrostatic latent image is formed to form a visualized image and transferring the visualized image to a transfer medium, wherein the toner is prepared using a method including preparing a latex for a core by polymerizing a composition for a core including (i) a macromonomer having a hydrophilic group, a hydrophobic group and at least one reactive functional group (ii) at least one polymerizable monomer and (iii) a wax; agglomerating the latex for a core by adding a pigment dispersion dispersed by the macromonomer and an inorganic salt to the prepared latex for a core; and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

A representative electrophotographic image forming process includes a series of processes of forming images on a receptor including charging, exposure to light, developing, transferring, fixing, cleaning, and erasing process operations.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an image-wise manner corresponding to a final visual image formed on a final image receptor to form a latent image. Electromagnetic radiation that can be referred to as “light” includes infrared radiation, visible light, and ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and form a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, residual toner remaining on the photoreceptor is removed.

Finally, in the erasing process, charges of the photoreceptor are exposed to light of a predetermined wavelength band and are reduced to be substantially uniform and of low value, and thus the residue of the organic latent image is removed and the photoreceptor is prepared for a next image forming cycle.

According to another embodiment of the present general inventive concept, there is provided an image forming apparatus including an organic photoreceptor, an image forming unit that forms an electrostatic latent image on a surface of the organic photoreceptor, a unit for receiving a toner, a toner supplying unit that supplies the toner onto the surface of the organic photoreceptor in order to form a toner image by developing the electrostatic latent image, and a toner transferring unit that transfers the toner image to a transfer medium from the surface of the organic photoreceptor. The toner used therein is prepared using a method including preparing a latex for a core by polymerizing a composition for a core including (i) a macromonomer having a hydrophilic group, a hydrophobic group and at least one reactive functional group (ii) at least one polymerizable monomer and (iii) a wax; agglomerating the latex for a core by adding a pigment dispersion dispersed by the macromonomer and an inorganic salt to the prepared latex for a core; and coating the agglomerated latex for a core using a latex for a shell layer, wherein the latex for a shell layer is prepared by polymerizing a composition for a shell layer including at least one polymerizable monomer, a macroinitiator having polydimethyl siloxane units, and a macromonomer.

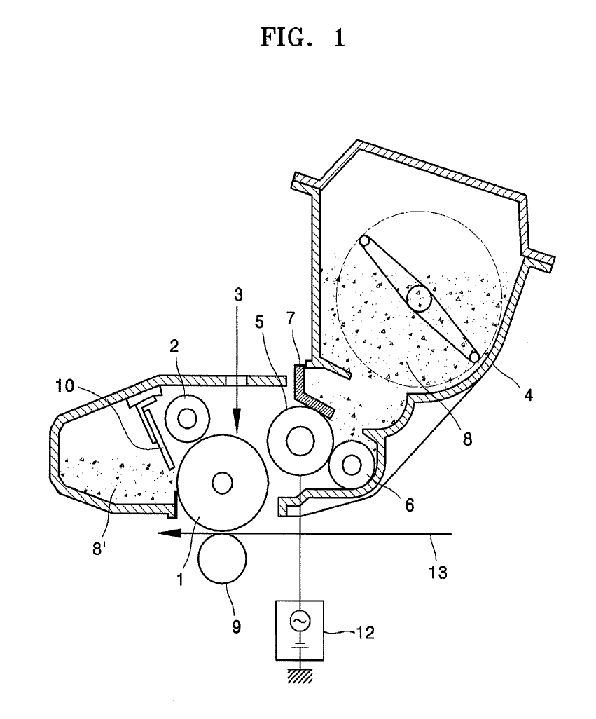

FIG. 1 shows a schematic diagram of a non-contact developing type image forming apparatus using a toner prepared using the method according to an embodiment of the present general inventive concept.

A developer 8, which is a nonmagnetic one-component developer of a developing unit 4, is supplied to a developing roller 5 through a feeding roller 6 formed of an elastic material, such as a polyurethane foam or sponge. The developer 8 supplied to the developing roller 5 reaches a contact point between the developing roller 5 and a developer regulation blade 7 as the developing roller 5 rotates. The developer regulation blade 7 is formed of an elastic material, such as metal and rubber. When the developer 8 passes the contact point between the developing roller 5 and the developer regulation blade 7, the developer 8 is smoothed to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 onto the photoreceptor 1.

The developing roller 5 and the photoreceptor 1 face each other with a constant distant therebetween. The developing roller 5 rotates counterclockwise and the photoreceptor 1 rotates clockwise.

The developer 8 transferred to the developing domain of the photoreceptor 1 forms a toner image by developing an electrostatic latent image on the photoreceptor 1 according to the intensity of the electric charge generated due to a difference between an AC voltage superposed with a DC voltage applied to the developing roller 5 and a latent image potential of the photoreceptor 1 that is charged by a charging unit 2.

The developer 8 developed on the photoreceptor 1 is transferred to a transferring unit 9 as the photoreceptor 1 rotates. The developer 8 developed on the photoreceptor 1 is transferred to a sheet of paper 13 by corona discharge or a roller to which a high voltage having inverse polarity of the developer 8 is applied as the paper 13 passes through the developer 8 developed on the photoreceptor 1, and thus an image is formed.

The image transferred to the printing paper 13 passes through a fusing device (not illustrated) that provides high temperature and high pressure, and the image is fused to the printing paper 13 as the developer 8 is fused to the printing paper 13. Meanwhile, the developer 8′ remaining on the developing roller 5 and which is not developed is transferred back to the feeding roller 6 contacting the developing roller 5. Remaining developer 8′ that is undeveloped on the photoreceptor 1 is collected by a cleaning blade 10. The above processes are repeated.

The present general inventive concept will be described in more detail with reference to the examples below, but is not limited thereto. The following examples are for illustrative purposes only and are not intended to limit the scope of the general inventive concept.

### Example 1

### Preparation of Latex for Core

While an inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 250 rpm.

100 g of a polymerizable monomer mixture of styrene, n-butyl acrylate, and methacrylic acid in a weight ratio of 75:23:2, 3.5 g of 1-dodecanethiol as a chain transfer agent, and 20 g of ester wax was melted at 60° C., and dispersed using ultrasonic waves for 5 minutes, and then added to the reactor, the temperature of which is maintained at 82° C. 2.0 g of potassium persulfate (KPS) dissolved in 50 g of deionized water as a water soluble free radical initiator was added to the reactor. The reaction was performed for 4 to 6 hours, and the resultant was cooled naturally while stirring. A particle size of the latex for a core was 200 nm, and a conversion rate was about 99.8%.

### Preparation of Latex for Shell Layer

While an inside of a reactor was purged with nitrogen gas, a mixture solution of 470 g of distilled deionized water and 5 g of poly(ethylene glycol)-ethyl ether methacrylate (PEG-EEM, Aldrich) as a macromonomer was added to the reactor and heated while stirring at 300 rpm.

A mixture of 10 g of VPS-0501 (Wako Pure Chemical Industries) as a macroinitiator having polydimethyl siloxane units, 100 g of a polymerizable monomer mixture of styrene, n-butyl acrylate, and methacrylic acid in a weight ratio of 75:23:2, and 3 g of 1-dodecanethiol as a chain transfer agent was dispersed using ultrasonic waves for 5 minutes. When the temperature in the reactor reached 82° C., the mixture was added to the reactor. The reaction was performed for 4 to 6 hours, and the resultant was cooled naturally while stirring. A particle size of the latex for a core was 80 nm, and a conversion rate was about 99.8%.

### Agglomeration and Preparation of Toner

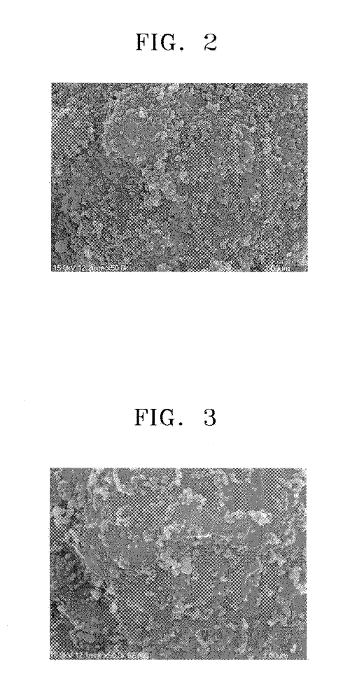

316 g of deionized water and 307 g of a latex for a core prepared according to the process described above were added to a 1 L reactor and stirred at 350 rpm. While stirring, 30 g of a black pigment dispersion which is dispersed by HS10 (DAIICHI) as a macromonomer was added thereto. The pH of the mixture was adjusted to 11, 30 g of MgCl₂ was added to the reactor, and the reactor was gradually heated to 95° C. The mixture was reacted at 95° C. for 2 hours, and reacted with NaCl for an additional 2 hours. 50 g of a latex for a shell layer was added thereto, the pH was adjusted to 11, and the mixture was reacted for 6 hours. Then, the mixture was cooled to a temperature of 25° C. which is below Tg, and filtered to separate toner particles and then dried. The dried toner particles were subjected to a surface treatment using silica, such as a mixture of H05TD (Wacker) and RX200 (NIPPON Aerosil), to prepare a final dry toner for a laser printer. As a result, the prepared toner particles had a volume average diameter of about 6.8 μm in an intermediate shape between potato-shape and spherical shape, and a SEM image thereof is illustrated in FIG. 2.

### Example 2

Toner was prepared in the same manner as in Example 1, except that a yellow pigment was used instead of the black pigment. The prepared toner had a volume average diameter of about 6.5 μm in a potato-shape, and a SEM image thereof is illustrated in FIG. 3.

### Example 3

Toner was prepared in the same manner as in Example 1, except that a cyan pigment was used instead of the black pigment. The prepared toner had a volume average diameter of about 6.4 μm in a potato-shape, and a SEM image thereof is illustrated in FIG. 4.

### Comparative Example 1

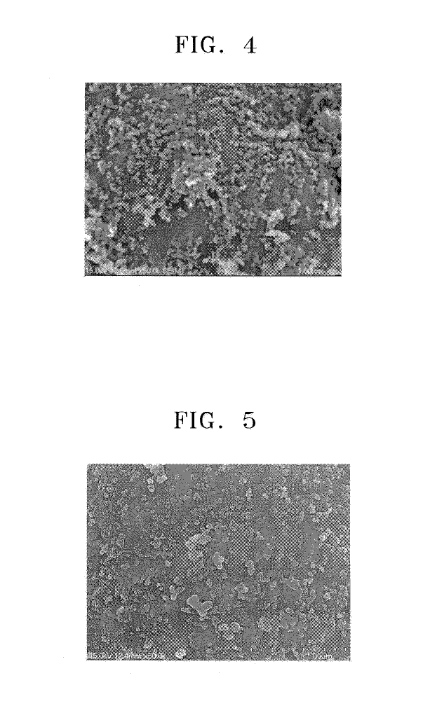

Toner was prepared in the same manner as in Example 1, except that KPS was used as an initiator in the preparation of the latex for a shell layer. The prepared toner had a volume average diameter of about 6.5 μm in a potato-shape, and a SEM image thereof is illustrated in FIG. 5.

### Comparative Example 2

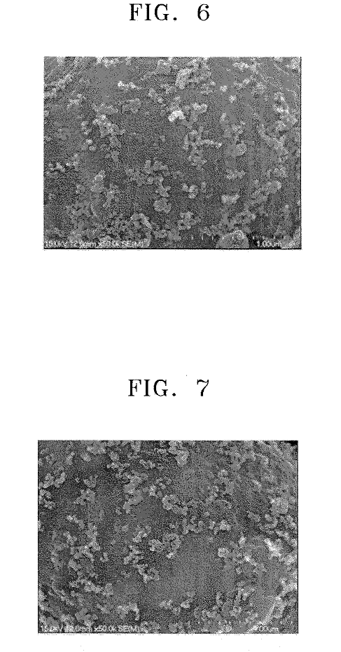

Toner was prepared in the same manner as in Comparative Example 1, except that a yellow pigment was used instead of the black pigment. The prepared toner had a volume average diameter of about 6.7 μm in a potato-shape, and a SEM image thereof is illustrated in FIG. 6.

### Comparative Example 3

Toner was prepared in the same manner as in Comparative Example 1, except that a cyan pigment was used instead of the black pigment. The prepared toner had a volume average diameter of about 6.4 μm in a potato-shape, and a SEM image thereof is illustrated in FIG. 7.

Referring to the SEM images of FIGS. 2 through 7, the results of the surface treated toner using external additives were compared. Adhesion of the toner according to Examples 1 through 3 (FIGS. 2 through 4) with the external additives were improved and a larger amount of silica used as the external additive are uniformly attached to the surface of the toner and the surface of toner particles is more deeply caved in compared to the toner according to Comparative Examples 1 through 3 (FIGS. 5 through 7).

Therefore, when a latex for a shell layer prepared using a macroinitiator having polydimethyl siloxane units is formed on the surface of the toner, affinity between the toner and external additives having a silicon-based component is improved. Thus, the amount of the external additives increases on the surface of the toner, and a uniform distribution of the external additives can be obtained compared to using the conventional initiator.

According to the present general inventive concept, toner having improved durability and excellent charge stability for high quality and high speed printers can be prepared by using simplified manufacture processes, which minimizes the amount of wastewater generated using a reduced amount of a surfactant, and improves affinity between toner and external additives by forming a shell layer having polydimethyl siloxane units to increase the amount of external additives on the surface of the toner and obtain uniform distribution of the external additives.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preparing toner, the method comprising:
preparing a latex for a core by polymerizing a composition for a core comprising:
a macromonomer having a hydrophilic group, a hydrophobic group, and at least one reactive functional group,
at least one polymerizable monomer,
and a wax,
agglomerating the latex for a core by adding a pigment dispersion dispersed by the macromonomer and an inorganic salt to the prepared latex for a core; and
coating the agglomerated latex for a core using a latex for a shell layer,
wherein the latex for a shell layer is prepared by polymerizing a composition for a shell layer including at least one polymerizable monomer, a macroinitiator having polydimethyl siloxane units, and a macromonomer.

2. The method of claim 1, wherein at least one operation of the preparing of a latex for a core, the agglomerating of the latex for a core, the preparing of a latex for a shell layer, and the coating of the agglomerated latex for a core using the latex for a shell layer is carried out without a surfactant.

3. The method of claim 1, wherein the weight average molecular weight of the macromonomer is in the range of 100 to 100,000.

4. The method of claim 1, wherein the macromonomer is selected from a group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

5. The method of claim 1, wherein the composition for a core comprises 0.5 to 10 parts by weight of the macromonomer and 1 to 20 parts by weight of the wax based on 100 parts by weight of the polymerizable monomer.

6. The method of claim 1, wherein the polymerizable monomer is at least one monomer selected from a group consisting of a vinyl monomer, a polar monomer having a carboxyl group, a monomer having an unsaturated polyester group, and a monomer having a fatty acid group.

7. The method of claim 1, wherein the polymerizable monomer is at least one monomer selected from a group consisting of styrene-based monomers, derivatives of (metha)acrylates, ethylenically unsaturated monoolefins, halogenized vinyls, vinyl esters, vinyl ethers, vinyl ketones, and nitrogen-containing vinyl compounds.

8. The method of claim 1, wherein the preparing of a latex for a core is carried out further using at least one selected from a group consisting of an initiator, a chain transfer agent, a charge control agent, and a release agent.

9. The method of claim 1, wherein the pigment is selected from a group consisting of yellow, magenta, cyan, and black pigments.

10. The method of claim 1, wherein the inorganic salt is at least one selected from a group consisting of NaCl, MgCl₂.8H₂O, [Al₂(OH)ₙCl₆₋ₙ]ₘ where 1≦n≦5 and 1≦m≦10, and (Al₂(SO₄)₃.18H₂O).

11. The method of claim 1, wherein the composition for a shell layer comprises 0.5 to 10 parts by weight of the macromonomer and 1 to 20 parts by weight of the macroinitiator having polydimethyl siloxane units based on 100 parts by weight of the polymerizable monomer.

12. The method of claim 1, wherein the macroinitiator having polydimethyl siloxane units is represented by Formula I below: 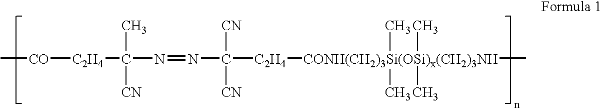
where, n is an integer from 1 to 50, and x is an integer from 20 to 1,000.

13. A Toner prepared using a method comprising:
preparing a latex for a core by polymerizing a composition for a core comprising:
a macromonomer having a hydrophilic group, a hydrophobic group, and at least one reactive functional group,
at least one polymerizable monomer,
and a wax,
agglomerating the latex for a core by adding a pigment dispersion dispersed by the macromonomer and an inorganic salt to the prepared latex for a core; and
coating the agglomerated latex for a core using a latex for a shell layer,
wherein the latex for a shell layer is prepared by polymerizing a composition for a shell layer including at least one polymerizable monomer, a macroinitiator having polydimethyl siloxane units, and a macromonomer, and wherein at least one operation of the preparing of a latex for a core, the agglomerating of the latex for a core, the preparing of a latex for a shell layer, and the coating of the agglomerated latex for a core using the latex for a shell layer is carried out without a surfactant.

14. Toner prepared using a method comprising:
preparing a latex for a core by polymerizing a composition for a core including:
a macromonomer having a hydrophilic group, a hydrophobic group and at least one reactive functional group,
at least one polymerizable monomer, and
a wax;
agglomerating the latex for a core by adding a pigment dispersion dispersed by the macromonomer and an inorganic salt to the prepared latex for a core; and
coating the agglomerated latex for a core using a latex for a shell layer,
wherein the latex for a shell layer is prepared by polymerizing a composition for a shell layer including at least one polymerizable monomer, a macroinitiator having polydimethyl siloxane units, and a macromonomer.

15. The toner of claim 14, wherein a volume average diameter of particles of the toner is in the range of 5 to 10 μm.

16. The toner of claim 14, wherein the macromonomer is selected from a group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

17. The toner of claim 14, wherein the macroinitiator having polydimethyl siloxane units is represented by Formula I below: 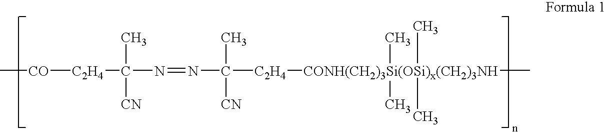
where, n is an integer from 1 to 50, and x is an integer from 20 to 1,000.

18. A method of forming an image using toner, the method comprising:
attaching the toner to a surface of a photoreceptor on which an electrostatic latent image is formed to form a visualized image; and
transferring the visualized image to a transfer medium,
wherein the toner is prepared using a method comprising:
preparing a latex for a core by polymerizing a composition for a core including:
a macromonomer having a hydrophilic group, a hydrophobic group and at least one reactive functional group,
at least one polymerizable monomer, and
a wax;
agglomerating the latex for a core by adding a pigment dispersion dispersed by the macromonomer and an inorganic salt to the prepared latex for a core; and
coating the agglomerated latex for a core using a latex for a shell layer,
and wherein the latex for a shell layer is prepared by polymerizing a composition for a shell layer including at least one polymerizable monomer, a macroinitiator having polydimethyl siloxane units, and a macromonomer.

19. An image forming apparatus comprising:
an organic photoreceptor;
an image forming unit that forms an electrostatic latent image on a surface of the organic photoreceptor;
a unit for receiving toner;
a toner supplying unit that supplies the toner onto the surface of the organic photoreceptor in order to form a toner image by developing the electrostatic latent image; and
a toner transferring unit that transfers the toner image to a transfer medium from the surface of the organic photoreceptor
wherein the toner is prepared using a method comprising:
preparing a latex for a core by polymerizing a composition for a core including:
a macromonomer having a hydrophilic group, a hydrophobic group and at least one reactive functional group,
at least one polymerizable monomer, and
a wax;
agglomerating the latex for a core by adding a pigment dispersion dispersed by the macromonomer and an inorganic salt to the prepared latex for a core; and
coating the agglomerated latex for a core using a latex for a shell layer,
and wherein the latex for a shell layer is prepared by polymerizing a composition for a shell layer including at least one polymerizable monomer, a macroinitiator having polydimethyl siloxane units, and a macromonomer.

20. The method of claim 7, wherein:
the styrene-based monomers is one of styrene, vinyl toluene, and α-methyl styrene;
the derivatives of (metha)acrylates is one of methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide;
the ethylenically unsaturated monoolefins is one of ethylene, propylene, and butylenes;
the halogenized vinyls is one of vinyl chloride, vinylidene chloride, and vinyl fluoride;
the vinyl esters is one of vinyl acetate, and vinyl propionate;
the vinyl ethers is one of vinyl methyl ether, and vinyl ethyl ether;
the vinyl ketones is one of vinyl methyl ketone, and methyl isoprophenyl ketone; and
the nitrogen-containing vinyl compounds is one of 2-vinylpyridine, 4-vinylpyridine, and N-vinyl pyrrolidone.
